(19) United States
(12) Patent Application Publication
(10) Pub. No.: US 2017/0140585 A1
(43) Pub. Date: May 18, 2017

(54) ACCESS CONTROL SYSTEM AND METHOD

(71) Applicant: Skookum, Inc., Charlotte, NC (US)

(72) Inventor: Evan Allen Booth, Greensboro, NC (US)

(21) Appl. No.: 15/298,702

(22) Filed: Oct. 20, 2016

Related U.S. Application Data
(60) Provisional application No. 62/257,036, filed on Nov. 18, 2015.

(51) Int. Cl. G07C 9/00

(52) U.S. Cl. CPC G07C 9/00158; G07C 9/00166

(57) ABSTRACT

An access control apparatus for a building includes: an access control device having a first state permitting movement through a portal of the building, and a second state hindering or preventing movement through the portal; a local controller associated with the access control device, and operable to cause the access control device to change between the first and second states in response to an external command; a plurality of informants, each operable to receive information related to access control; and a main controller programmed to: receive the information from the plurality of informants; apply one or more rules to the information; generate an access control decision based on application of the rules; and provide commands to the local controller based on the access control decision. An access control network interconnects at least the main controller, the plurality of informants, and the local controller.

### BACKGROUND OF THE INVENTION

This invention relates generally to access control systems and more particularly to access control systems using a plurality of networked sensors.

Devices such as gates, magnetic locks (“maglocks”) and electric door strikers are known for use in controlling access to buildings and interior spaces. It is further known to control such devices manually or remotely, for example by opening a door when a proximity sensor is triggered.

Such devices, while effective, have limited flexibility which depends on a specific hardware configuration and usually of fixed sensor response logic.

Accordingly, there remains a need for a flexible access control system.

### BRIEF SUMMARY OF THE INVENTION

This need is addressed by aspects of the technology described herein, which provides a network-based access control system and method for its operation.

According to one aspect of the technology described herein, an access control apparatus for a building includes: an access control device having a first state permitting movement through a portal of the building, and a second state hindering or preventing movement through the portal; a local controller associated with the access control device, and operable to cause the access control device to change between the first and second states in response to an external command; a plurality of informants, each operable to receive information related to access control; and a main controller programmed to: receive the information from the plurality of informants; apply one or more rules to the information; generate an access control decision based on application of the rules; and provide commands to the local controller based on the access control decision. An access control network interconnects at least the main controller, the plurality of informants, and the local controller.

According to another aspect of the technology described herein, a method for controlling an access control device of the type having a first state that permits movement through a portal of a building, and a second state that hinders or prevents movement through the portal, the method including: collecting information related to access control from a plurality of informants; transferring the information from the plurality of informants to a main controller, over an access control network; using the main controller to: receive the information from the plurality of informants; apply one or more rules to the information from the plurality of informants; and generate an access control decision based on the application of the one or more rules, transferring commands based on the access control decision from the main controller to a local controller over the access control network; and using a local controller associated with the access control device, causing the access control device to change between the first and second states in response to the commands.

### BRIEF DESCRIPTION OF THE DRAWINGS

The invention may be best understood by reference to the following description taken in conjunction with the accompanying drawing figures, in which:

FIG. 1 is schematic diagram of an access control system; and

FIG. 2 is a schematic diagram of a user interface to a software administrative control.

### DETAILED DESCRIPTION OF THE INVENTION

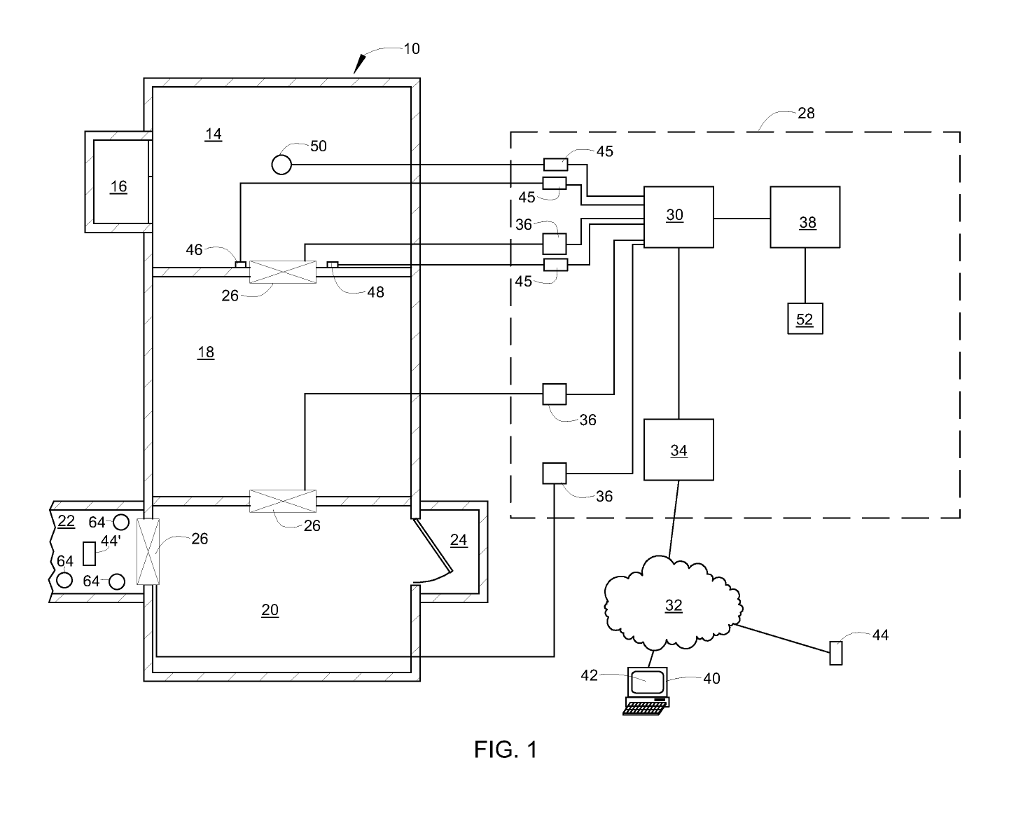

Referring to the drawings wherein identical reference numerals denote the same elements throughout the various views, FIG. 1 shows an exemplary access control system implemented in a building 10 which includes one or more physical zones, defined as areas physically separated from each other by walls 12 or similar structures. This particular example includes several zones, specifically: an elevator lobby 14 accessed from an elevator 16, a main lobby 18, a first internal zone 20, and a second internal zone 22. As an example, the first internal zone 20 may be a “public” area with access to facilities such as a restroom 24, and the second internal zone 22 may be a private area with more restricted access (e.g. private offices, etc.). These zones are merely examples of myriad different internal building arrangements.

The building 10 includes several access control devices 26. An access control device 26 is positioned between the elevator lobby 14 and the main lobby 18, between the main lobby 18 and the first internal zone 20, and between the first internal zone and the second internal zone 22. As used herein, the term “access control device” refers to physical hardware that controls access through a portal such as a door or passageway. The distinguishing feature of an “access control device” is the ability to have a first physical state, position, or condition that permits movement through a portal and a second physical state, position, or condition that hinders or prevents movement through the portal. For convenience these may be referred to as first and second states of the access control device. Non-limiting examples of access control devices include doors with locking devices such as magnetic locks (“maglocks”) or electric strikers, actuated doors, gates, and turnstiles.

In general the access control device 26 can be controlled by a simple control signal, for example a low-voltage DC current may be applied to a specific set of physical terminals which is turn operates a transistor, relay, etc. to operate the electrical or electromechanical components of the access control device. For example, applying 24V DC to an “open” terminal may cause an electric striker to retract and permit a door to be opened manually. Optionally, the access control device 26 may include a feedback means operable to communicate its current state (i.e. open/closed).

The access control devices 26 are controlled by a plurality of devices operating with an access control network 28, shown by a dashed line in FIG. 1. Functional connections for transporting power and/or data into, out of, or within the access control network 28 are illustrated in FIG. 1 as single lines, with the understanding that such connections may wired or wireless. The various components of the access control network 28 may be interconnected, for example, using a conventional Ethernet switch 30. Optionally, the access control network 28 may be connected to a wide area network (WAN) such as the public Internet 32, for example using the illustrated access point device 34.

A local controller 36 is associated with each access control device 26. The function of the local controller 36 is to operate the access control device 26, for example by providing the simple control signal described above. The local controller 36 includes one or more relays, transistors, or similar switching devices as required to provide the simple control signal. The local controller 36 also includes one or more electronic processors operable to executed programmed instructions, as well as means for two-way communication of data over a network. The local controller 36 may be implemented, for example, using a conventional microcomputer including a network interface card or wireless transceiver. To save costs the local controller 36 may be a device such as a single-board computer. For convenience the local controller 36 may be located in close proximity to the respective access control device 26.

The system includes a main controller 38. The function of the main controller 38 is to provide commands to the local controllers 30 and to provide other services required by the access control network 28 including but not limited to: network authentication, hosting a management interface (described in more detail below), access control device operating logic, dynamic host configuration protocol (“DHCP”)/access control, and data logging. The main controller 38 may also include or have access to one or more electronic processors operable to executed programmed instructions as well as well as means for two-way communication of data over a network. The main controller 38 may be implemented, for example, using a conventional microcomputer including a network interface card or wireless transceiver. Alternatively, the main controller 38 could be a virtual controller, implemented as software operating on a computer in communication with the access control network 28.

The system incorporates one or more informants in communication with the access control network 28. As used herein, the term “informant” is defined as a device or service that receives information related to access control and passes the information on to the main controller 38. Each informant incorporates means for two-way communication of data over a network. Nonlimiting examples of informants include devices such as key card or access card readers, sensors operable to detect a physical condition within the building 10 such as proximity sensors (e.g. active or passive infrared or ultrasonic), biometric sensors (e.g. fingerprint readers, facial recognition sensors, weight sensors), physical switches or input devices (e.g. touchscreen, keyboard, or keypad). The informant could be virtual in whole or part, implemented as software running on a computer. For example, an Internet-connected computer 40 hosting software 42 such as a public or private website or a calendaring system may be used as an informant. A mobile computing device (e.g. “smartphone”) 44 with appropriate software could also be used to host or provide an access channel to one or more informant(s), or may serve as an informant itself. It is noted that individual informants may incorporate a sensor interface 45 connected to a conventional sensor. The sensor interface 45 may include one or more electronic processors operable to executed programmed instructions, as well as means for two-way communication of data over a network.

The mobile device may incorporate appropriate software (e.g. an “app”) configured to operate with the access control network 28. The app may be used to facilitate or automate various access control functions. For example, the app may be programmed to use a location service (e.g. GPS, or cellular-based location service) to determine the physical location of the mobile device 44, to compare that physical location with an internal map to determine if the mobile device is in a predefined close proximity to an access device 26, and then to send one or more pieces of information (e.g. numeric code, biometric information) to the main controller 38 through the access control network 28.

The system described above permits the implementation of one or more rules in unlimited combinations for controlling and operating the access control devices 26. In general, the system operates by receiving and passing along information from one or more informants to the main controller 38. The main controller 38 analyzes the information with reference to the rules, or stated another way it applies the rules to the information from the informants, and makes an authentication decision, also referred to herein as an access control decision. When access is permitted based on the analysis, that is when the decision is to allow access, the main controller 38 passes instructions or commands to the relevant local controller 36 which in turn operates the corresponding access control device 26. Several examples will now be set forth of potential operational scenarios.

### Example 1

In this example, the system can be programmed to receive information from two or more informants and provides access if the information from all of the informants satisfies relevant rules. For example, a hypothetical user “Bill” might be a vendor representative who is permitted into public areas of the building premises for scheduled appointments during normal business hours, e.g. 9 am to 5 pm Monday through Friday. Bill may approach the elevator lobby 14 and may input a numeric code into a keypad 46 (i.e. a first informant). Alternatively, the numeric code could be supplied using a mobile computing device 44 described above. The numeric code may be listed in a database within the main controller 38 as a valid code which has previously been assigned to Bill. Tentatively, then, the user is identified as Bill.

Bill may also be observed by a second informant in the form of a biometric sensor 48 (e.g. fingerprint, weight measuring plate, and/or facial recognition camera). Alternatively, biometric data could be supplied using the mobile computing device 44 described above. A sufficient match between the biometric data and stored biometric data would positively identify Bill. Separately, the main controller 38 has access to a calendaring system 42 (a third informant) which lists the date and time of scheduled appointments. The main controller 38 would compare the current date and time with the date and time of a scheduled appointment. For example, if an appointment is scheduled for 1:00 pm on a specific day and is expected to last one hour, the system may permit access for a short time before and after. If Bill arrived between 12:50 pm and 2:10 pm, access would be permitted.

Having positively identified the user and his presence at an authorized time, the main controller 38 would signal the appropriate local controller 36 to open the access control device 26 between the elevator lobby 14 and the main lobby 18. Subsequently, if Bill attempts to enter the first internal zone 20, the main controller 38 would signal the appropriate local controller 36 to open the access control device 26 between the main lobby 18 and the first internal zone 20. However, if Bill attempts to enter the second internal zone 22, access would be denied.

### Example 2

The system may be programmed to receive information from two or more informants and deny access if the informants show an undesirable pattern. For example, a user “Jack” might be a company employee who is permitted into public and private areas of the building premises during normal business hours, e.g. 9 am to 5 pm Monday through Friday. A first informant (e.g. keypad 46) may receive a numeric code. The code may be listed in a database within the main controller 38 as a valid code which has previously been assigned to Jack. Tentatively, then, the user is identified as Jack. At the same time, the elevator lobby 14 may be observed by a second informant in the form of a proximity sensor 50 (e.g. infrared or ultrasonic). This might indicate a large group of people present in the elevator lobby 14 near the access control device 26. This incongruous information (one confirmed identification but the presence of multiple people) could be an indication of a violation of company access policy or a criminal attempt to enter the building 10. The main controller 38 could be programmed to deny access under these circumstances.

### Example 3

The system may be programmed with starting rules similar to the example cases described above, but may be programmed with flexible boundaries. The system may operate to permit access if data fits within a predefined, less-than-complete match with established parameters. This type of flexible boundary may be useful for data that is likely to vary and/or have a significant error rate. For example, a user's measured weight may vary from an established value for reasons such as moderate weight gain or loss, different types of clothing, and/or different amounts of personnel effects. The system could be programmed to permit a “match” if the measured weight is within a few percentage points of the established value.

### Example 4

The system is not limited to fixed logic, and may be programmed to learn and establish limits. For example, the main controller 38 could be programmed to follow initial rules during a “learning” phase, meanwhile logging information and recording statistics establishing nominal baselines. For example, the system may record biometric information, time delays between entrances and exits, and so forth. Subsequently, the system may operate in an “anomaly detection” mode in which access is denied if the sensed data from one or more informants varies from nominal by a statistically significant amount.

### Example 5

In this example, the system can be programmed to modify or ignore information from one or more informants. For example, a hypothetical user “Joe” might be a company employee who is permitted into public and private areas of the building premises during normal business hours, e.g. 9 am to 5 pm Monday through Friday (similar to the employee Jack described above). Upon coming into a predefined close proximity to an access control device 26, a mobile computing device 44′ in Joe's possession may transmit a numeric code, as described above. The numeric code may be listed in a database within the main controller 38 as a valid code which has previously been assigned to Joe.

However, it may occur that the location service used by the mobile computing device 44′ is not accurate enough to determine whether the access control device 26 should be activated or not. For example, it may occur that Joe may be in the main lobby 18, in which case the access control device 26 controlling the entry door should open to permit entry, or it may be that Joe has already entered the building 10 and is actually in the internal zone 22. In such circumstances it is not desirable to open the door controlled by the access control device 26. In such a circumstance, the output of the mobile computing device 44′ could be modified as follows: one or more stationary beacons 64 transmitting a wireless signal of predetermined characteristics may be placed within the internal zone 22. Upon receipt of the signal from a sufficient number of beacons 64, the mobile device 44′ may determine that its position is in fact within the internal zone 22. Under the circumstances, mobile device 44′ would not send the numeric code requesting operation of the access control device 26, despite the indication of close proximity from the location service. The beacons 64 are merely one example of a device that could be used to validate or confirm the exact position of the mobile device 44′.

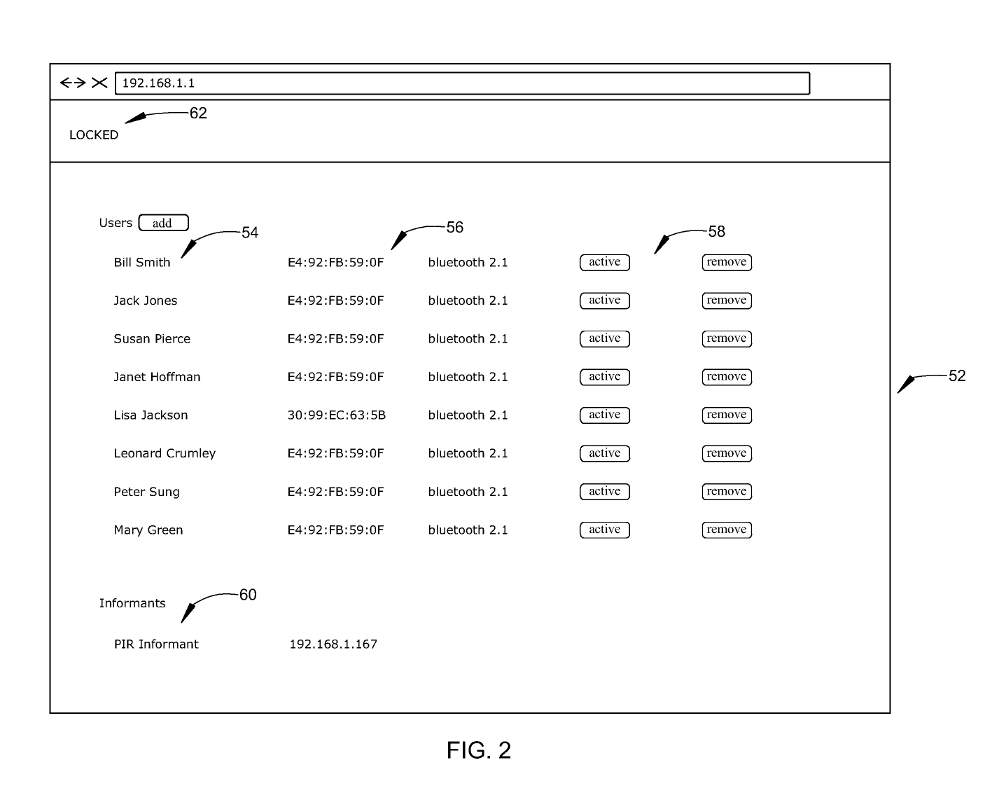

The system may be controlled through an administrative interface 52, for example in the form of a software application hosted by the main controller 38. FIG. 2 illustrates an example of a one user interface screen having a listing 54 of users with reference information 56, and control buttons 58 for adding, removing, or editing users. The interface 52 also includes a listing 60 of active informants along a status indicator 62 for one or more access control devices. The administrative interface 52 may also be used to implement manual override control of one or more of the access control devices 26, and to edit the access control logic algorithms and databases.

The apparatus and process described above has the advantage and effect of implementing access control in a flexible manner, permitting the collection of data from many sources, the analysis of the data using fixed or dynamic logic, and finely-granulated control of the access control devices 26.

The foregoing has described apparatus and method for physical access control. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. An access control apparatus for a building, comprising:
an access control device having a first state that permits movement through a portal of the building, and a second state that hinders or prevents movement through the portal;
a local controller associated with the access control device, the local controller operable to cause the access control device to change between the first and second states in response to an external command;
a plurality of informants, each informant operable to receive information related to access control; and
a main controller programmed to:
receive the information from the plurality of informants;
apply one or more rules to the information from the plurality of informants;
generate an access control decision based on the application of the one or more rules; and
provide commands to the local controller based on the access control decision; and
an access control network interconnecting at least the main controller, the plurality of informants, and the local controller, the access control network operable to permit transport of the information and the commands.

2. The access control apparatus of claim 1 wherein the access control device is a magnetic lock or an electric striker operable to selectively permit opening of a door.

3. The access control apparatus of claim 1 wherein at least one of the informants comprises a physical sensor operable to detect a physical condition within the building and produce a signal in response thereto.

4. The access control apparatus of claim 3 wherein the physical sensor is operably connected to a sensor interface including one or more electronic processors operable to execute program instructions, and means for communications of data over the access control network.

5. The access control apparatus of claim 1 wherein at least one of the informants comprises a biometric sensor.

6. The access control apparatus of claim 1 wherein at least one of the informants is a network-connected computer.

7. The access control apparatus of claim 1 wherein at least one of the informants is virtual in whole or part, implemented as software running on a computer.

8. The access control apparatus of claim 7 wherein the informant comprises or is hosted by a mobile computing device.

9. The access control apparatus of claim 1 wherein the access control network is connected to a wide area network.

10. A method for controlling an access control device of the type having a first state that permits movement through a portal of a building, and a second state that hinders or prevents movement through the portal, the method comprising:
collecting information related to access control from a plurality of informants;
transferring the information from the plurality of informants to a main controller, over an access control network;
using the main controller to:
receive the information from the plurality of informants;
apply one or more rules to the information from the plurality of informants; and
generate an access control decision based on the application of the one or more rules,
transferring commands based on the access control decision from the main controller to a local controller over the access control network; and
using a local controller associated with the access control device, causing the access control device to change between the first and second states in response to the commands.

11. The method of claim 10 wherein at least one of the informants comprises a physical sensor operable to detect a physical condition within the building and produce a signal in response thereto.

12. The method of claim 11 wherein the physical sensor is operably connected to a sensor interface including one or more electronic processors operable to execute program instructions, and means for communications of data over the access control network.

13. The method of claim 11 wherein the step of applying one or more rules comprises denying access if the information from the sensor is inconsistent with information from the other informants.

14. The method of claim 10 wherein the step of applying one or more rules comprises permitting access if the information from the plurality of informants fits within a predefined, less than complete match with established parameters.

15. The method of claim 10 wherein the step of applying one or more rules comprises:
following initial rules during a learning phase;
logging information and recording statistics establishing nominal baselines; and subsequent to the learning phase, denying access if the information from one or more informants varies from the nominal baselines by a statistically significant amount.

16. The method of claim 10 wherein the access control device is a magnetic lock or an electric striker operable to selectively permit opening of a door.

17. The method of claim 10 wherein at least one of the informants comprises a biometric sensor.

18. The method of claim 10 wherein at least one of the informants is virtual in whole or part, implemented as software running on a computer.

19. The method of claim 18 wherein the informant comprises or is hosted by a mobile computing device.

20. The method of claim 10 wherein information is transferred at least one of the informants to the access control network through a wide area network.
